(19) United States
(12) Patent Application Publication
(10) Pub. No.: US 2015/0220115 A1
(43) Pub. Date: Aug. 6, 2015

(54) MOBILE TERMINAL

(71) Applicant: Xiaomi Inc., Beijing (CN)

(72) Inventors: Yuan Gao, Beijing (CN); Gaocai Han, Beijing (CN); Hongzhi Jin, Beijing (CN); Bin Zhang, Beijing (CN)

(21) Appl. No.: 14/685,605

(22) Filed: Apr. 14, 2015

Related U.S. Application Data
(63) Continuation of application No. PCT/CN2014/091193, filed on Nov. 14, 2014.

(30) Foreign Application Priority Data
Jan. 26, 2014 (CN) 201410038298.5

(51) Int. Cl. G06F 1/16

(52) U.S. Cl. CPC G06F 1/1633

(57) ABSTRACT

The present disclosure provides a mobile terminal. The mobile terminal includes a middle casing (5) configured as a core support of the mobile terminal; a front casing (6) fixed on a front side of the middle casing (5); a back cover (3) fixed on a back side of the middle casing (5) and configured to cover the back side of the middle casing (5); a battery cover (1) fixed on the back cover (3) and configured to cover a battery; and a display screen (7) and a touch screen (8) arranged on the front casing (6) in series, wherein the front casing (6) is configured to support the display screen (7) and the touch screen (8), and the display screen (7) is positioned between the front casing (6) and the touch screen (8).

### CROSS REFERENCE TO RELATED APPLICATION

This application is a Continuation of International Application No. PCT/CN2014/091193, filed on Nov. 14, 2014, which claims priority to Chinese Patent Application No. 201410038298.5, filed on Jan. 26, 2014, the entire contents of which are incorporated herein by reference.

### TECHNICAL FIELD

The present disclosure relates to mobile terminal assembling technology, and more particularly, to a mobile terminal.

### BACKGROUND

Individual element design is the key step in structural design of mobile terminals such as mobile phones, tablet computers, PDAs, and etc. The individual element design refers to a design where the mobile terminal can be disassembled into individual components that can facilitate production and perform certain functions. According to the individual element design, the overall mobile terminal can be assembled, disassembled and maintained by using independent components. In a mobile terminal, the electronic components (e.g., chips, resistors, capacitors, etc.) are standard elements whose sizes generally cannot change. The mechanical components (such as casings of mobile terminals, support frames of electronic apparatus, etc.) are customized elements whose structures and sizes could be designed based on actual situations. The individual element design relates to designing the customized elements.

Currently, there are two common mobile terminal structures. The first terminal structure is a structure consisting of a front casing and a back casing, i.e. the overall structure of the mobile terminal is formed by the front casing and the back casing, in which the front casing is provided with a liquid crystal display (LCD), support frames and various other elements, while the back casing is an appearance component enclosing the periphery and bottom of the mobile terminal. The other terminal structure is a structure consisting of the front casing, the back casing and a battery cover, in which the back casing is further provided with the battery cover for attaching and detaching a battery in addition to the first terminal structure.

The aforementioned two mobile terminal structures both consist of relatively fewer components, thus each component must carry many electronic elements of the mobile terminal (for example, many elements are attached to the front casing). Because most of the electronic elements of the mobile terminal are standard elements, the structure of each component must meet a mounting requirement of each electronic element arranged thereon, and hence the structures of most components of the mobile terminal are relatively complicated. The more complicated the structure of the component is, the more complicated the manufacturing process of the component is, which leads to an increase in the manufacturing cost of the component. Moreover, the complicated manufacturing process may result in a lower yield of the component, which further increases the manufacturing cost. If there is any slight impact on the mobile terminal during operation, the components with complicated structures may need maintenance, or even the entire assembly may be damaged, which in turn leads to high maintenance cost of the components. Thus, the components of complicated structures have higher manufacturing cost and maintenance cost, and thus the mobile terminals will have higher manufacturing cost and maintenance cost, thereby weakening the market competitiveness of the mobile terminals.

### SUMMARY

The present disclosure provides a mobile terminal.

According to a first aspect of embodiments of the present disclosure, a mobile terminal is provided. The mobile terminal includes a middle casing configured as a core support of the mobile terminal; a front casing fixed on a front side of the middle casing; a back cover fixed on a back side of the middle casing and configured to cover the back side of the middle casing; a battery cover fixed on the back cover and configured to cover a battery; and a display screen and a touch screen arranged on the front casing in series, wherein the front casing is configured to support the display screen and the touch screen, and the display screen is positioned between the front casing and the touch screen.

The technical solution of embodiments of the present disclosure has the following advantages.

The overall mobile terminal have more components including the middle casing, the front casing, the back cover, the display screen, the touch screen and the battery cover, such that the electronic elements can be distributed on more components compared with the conventional designs. Accordingly, there are fewer electronic elements on each component, thus avoiding forming more mounting structures on each component. In such a case, the manufacturing complexity of each component can be reduced, and the manufacturing process can be simplified, thereby improving the component manufacturing yield. Because of the more components, the significance and cost of each component are decreased, and the damage of each component caused by failures is reduced, thereby bringing down the maintenance cost of components. In terms of the overall mobile terminal, both the manufacturing cost and the maintenance cost can be reduced accordingly.

It shall be understood that the above description and the following detailed description are only exemplary, and cannot be construed to limit the present disclosure.

### BRIEF DESCRIPTION OF THE DRAWINGS

In order to more clearly illustrate the technical solution in the embodiment of the present disclosure, drawings for description of the embodiment are briefly introduced. Obviously, those skilled in the art can obtain other drawings based on the following drawings, without involving creative efforts.

FIG. 1 is an exploded schematic view of a mobile terminal according to an exemplary embodiment;

FIG. 2 is a partial schematic view of the mobile terminal of FIG. 1 according to an exemplary embodiment;

FIG. 3 is a schematic view of a middle casing according to an exemplary embodiment;

FIG. 4 is a partial cross-section schematic view of the mobile terminal according to an exemplary embodiment;

FIG. 5 is a schematic view showing of a plurality of sub-areas of a frame of the mobile terminal according to an exemplary embodiment.

The drawings are incorporated as a part of the specification to show the embodiment fulfilling the present invention and explain, along with the specification, the principle of the invention.

### DETAILED DESCRIPTION

The embodiments of the present disclosure provide a mobile terminal, which solves the problem discussed in the background, i.e. high manufacturing cost and maintenance cost.

The technical solution in the embodiment of the present disclosure will be further illustrated in detail with reference to the drawings of the specification, such that those skilled in the art can understand the technical solution better, and the objective, characteristics and advantages of the embodiment may become apparent and more readily appreciated.

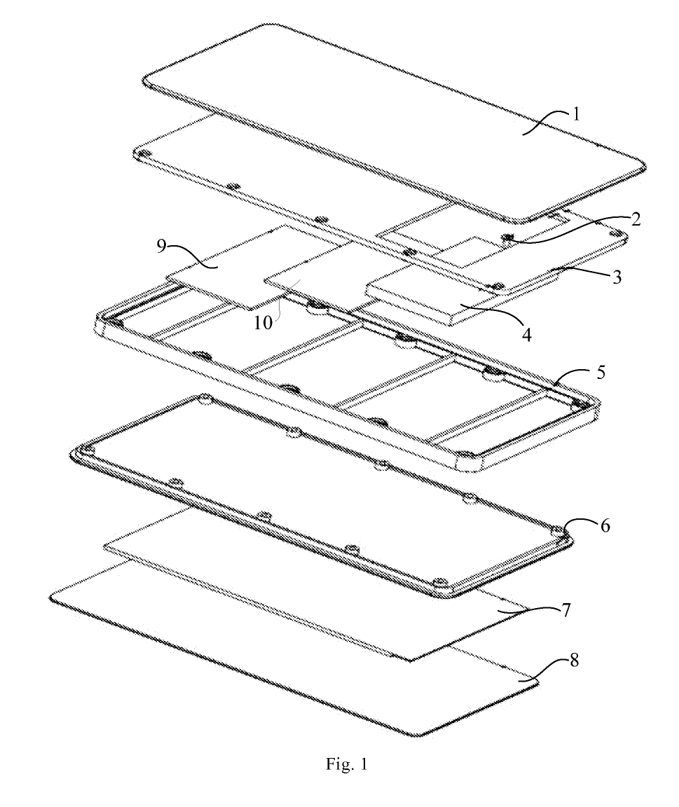

Referring to FIG. 1, it shows a structure of a mobile terminal according to an embodiment of the present disclosure. The mobile terminal shown in FIG. 1 includes a middle casing 5, a front casing 6, a back cover 3, a battery cover 1, a display screen land a touch screen 8.

The middle casing 5 is the main support frame of the mobile terminal according to the embodiment, which is configured as a core support of the mobile terminal. The middle casing 5 is configured to support electronic elements of the mobile terminal arranged thereon, and further configured as a mounting base for the front casing 6 and the back cover 3. Correspondingly, the outer peripheral surface of the middle casing 5 forms a part of the outer side surface of the mobile terminal, or configured as the overall outer side surface of the mobile terminal.

The front casing 6 is a front casing body of the overall mobile terminal, and is fixed on a front side of the middle casing 5. Generally, the front casing 6 is an auxiliary component that functions as a support base of the display elements. In other words, the front casing 6 is configured to support the display screen 7 and the touch screen 8.

The back cover 3 is a back casing body of the overall mobile terminal, and is fixed on a back side of the middle casing 5 to cover the back side of the middle casing 5. Moreover, the back cover 3 provides a mounting base for elements of the mobile terminal, such as an antenna and flexible boards. The battery cover 1 is fixed on the back cover 3 to cover a battery. Generally, the back cover 3 of the mobile terminal has a window allowing for removing batteries. The configuration of the battery cover 1 simplifies the removal of battery from the mobile terminal, as it is merely needed to open the battery cover 1 during the battery attaching or detaching process.

The display screen 7 and the touch screen 8 are the display component and the operation component of the mobile terminal, respectively, and are arranged (e.g. fixed) on the front casing 6 in series, and the display screen 7 is disposed between the front casing 6 and the touch screen 8.

Different from the conventional designs, the mobile terminal according to the embodiment of the present disclosure has more components, including the middle casing 5, the front casing 6, the back cover 3, the battery cover 1, the display screen 7 and the touch screen 8. Thus, the electronic elements of the mobile terminal can be distributed on the more components rather than clustered on the front casing as conventional designs. Correspondingly, there are fewer electronic elements on each component, such that each component does not need to be provided with more mounting structures, which can reduce the manufacturing complexity of each component and simplify the manufacturing process, thus improving the component manufacturing yield. Because of the more components, the significance and cost of each component are decreased significantly, and the damage of components caused by failures is reduced, thereby bringing down the maintenance cost of components. Consequently, both the manufacturing cost and the maintenance cost of the mobile terminal can be reduced.

As the mobile terminal has more components, most of the elements and components can be recycled when the exterior surface of the mobile terminal is damaged, and thus the manufacturing cost and the maintenance cost of the mobile terminal can be further reduced.

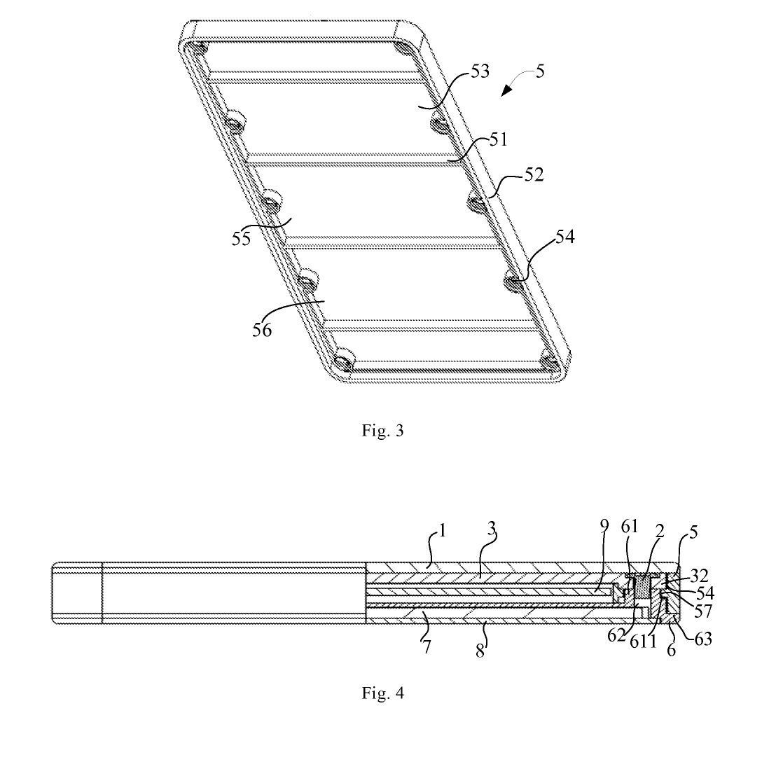

The middle casing 5 as the main support frame of the mobile terminal can have various structures, which can be determined according to the specific type of mobile terminals. Generally, the middle casing 5 needs to have a relatively higher strength to optimize the support function. Therefore, manufacturers tend to employ materials of higher strength (e.g. metals) as the material of the middle casing 5. However, that will increase the manufacturing cost of the middle casing 5. In order to solve the above problem concerning cost, embodiments of the present disclosure provide a middle casing of a specific structure. Referring to FIG. 3, the middle casing shown in FIG. 3 includes a frame 52 and at least a transverse beam 51. The transverse beam 51 is disposed in the frame 52 and divides the area enclosed by the frame 52 into a plurality of sub-areas suitable for the arrangement of the electronic elements of the mobile terminal. The middle casing 5 has a frame structure (like a skeleton of a building), which can improve the strength of the middle casing 5. The transverse beam 51 further enhances the strength of the overall middle casing 5 and functions to form distribution areas for the various electronic elements. In the embodiment of the present disclosure, the middle casing 5 has a frame structure that is simple and has high replaceability, and therefore the maintenance cost can be significantly controlled if there is any damage.

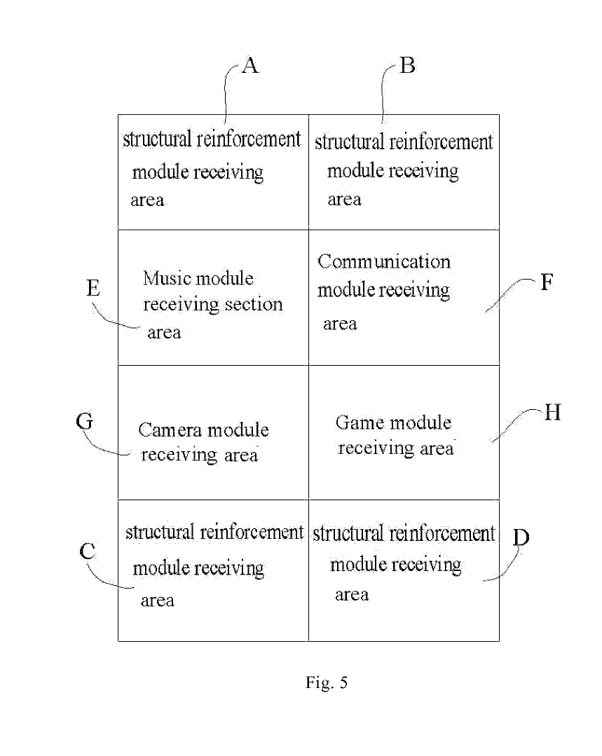

Still referring to FIG. 3, the plurality of sub-areas may include a circuit board receiving area (for example, a circuit board receiving area 53 and a circuit board receiving area 55 configured to mount and receive a circuit board 9 and a circuit board 10, respectively) and a battery receiving area 56 (the battery receiving area 56 configured to receive a battery 4). Moreover, the plurality of sub-areas may have other functions, and the embodiment of the present disclosure does not limit the function of the sub-areas. Moreover, the embodiment is not limited to divide the area into sub-areas by using the transverse beams, which can also be realized by using longitudinal beams (i.e. the beams extending in the length direction of the mobile terminal) or by using a combination of the longitudinal beams and the transverse beams. Referring to FIG. 5, it shows a sub-area dividing method, in which the area enclosed by the frame 52 is divided into a structural reinforcement module receiving area (including a structural reinforcement module receiving area A, a structural reinforcement module receiving area B, a structural reinforcement module receiving area C and a structural reinforcement module receiving area D), a music module receiving area E, a communication module receiving area F, a camera module receiving area G and a game module receiving area H. Those skilled in the art can adjust the numbers of the transverse beams 51 and the longitudinal beams, and the configuration thereof based on the type of mobile terminals and the arrangement of electronic elements. The embodiment of the present disclosure should not be constructed to limit the numbers of the transverse beams 51 and the longitudinal beams, and the configuration thereof.

When the sub-areas include the battery receiving area 56, an operation window 31 for battery attaching and detaching is formed at a position of the back cover 3 corresponding to the battery receiving area 56. In such a way, the battery can be substantially exposed from the back cover 3, so that the other electronic elements of the mobile terminal on the back cover 3 will not be damaged during the operation process, because the battery can be attached or detached through the operation hole 31. In the actual detaching process, other elements of the mobile terminal may be frequently attached or detached as well, for example, a smart card. Therefore, the back cover 3 may have other operation holes corresponding to some other elements.

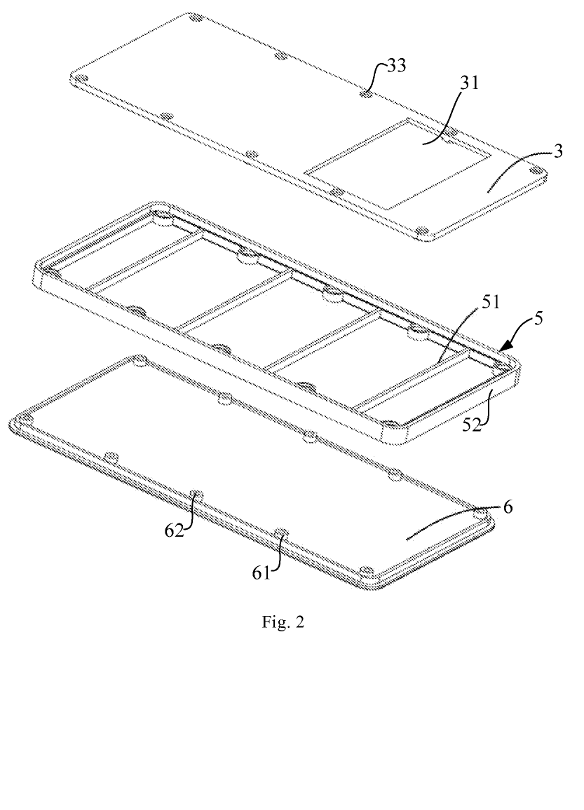

In the mobile terminal of the embodiment of the present disclosure, the front casing 6 is fixed on the front side of the middle casing 5, the back cover 3 is fixed on the back side of the middle casing 5, and the above components can be fixed via direct fixation. That is, the front casing 6 is directly fixed on the front side of the middle casing 5 via a connecting member or a connecting structure; and the back cover 3 is directly fixed on the back side of the middle casing 5 via a connecting member or a connecting structure. Alternatively, the front casing 6 may be fixed on the back side of the middle casing 5 via an indirect fixation. For example, the front casing 6 is fixed with the back casing 3, and the middle casing 5 is clamped therebetween. In the fixation process, fixation can be implemented by using connecting members or connecting structures (e.g. snap-fit structures). Referring to FIGS. 2, 3 and 4, the embodiment of the present disclosure provides a connecting structure. In the embodiment, connecting holes are arranged at corresponding positions on edges of the front casing 6, the middle casing 5 and the back cover 3, respectively, i.e. a first connecting hole 33, a second connecting hole 57 and a third connecting hole 62. In particular, the first connecting hole 33 is formed in the back cover 3, the second connecting hole 57 is formed in the middle casing 5, and the third connecting hole 62 is formed in the front casing 6. The front casing 6, the middle casing 5 and the back cover 3 are connected together via a connecting member to be disposed in these connecting holes. The connecting member may be, for example, a threaded connecting member. During assembling, after the connecting holes on the front casing 6, the middle casing 5 and the back cover 3 are aligned with each other, the front casing 6, the middle casing 5 and the back cover 3 are connected via the connecting member so as to implement a fixed assembly.

If the front casing 6, the middle casing 5 and the back cover 3 are connected via the connecting members after simple superposition, the assembly may have poor stability, and the volume of the overall mobile terminal may be relatively big. In order to solve these problems, the back cover 3 in the embodiment of the present disclosure is provided with a first protrusion 32 at a position of the front side surface of the back cover 3 corresponding to the first connecting hole 33, and a recess 54 is arranged at a position of the middle casing 5 corresponding to the first protrusion 32, and the recess 54 is fitted with the first protrusion 32 to position the back cover 3 and the middle casing 5. In such a way, after the first protrusion 32 is fitted with the recess 54, the back cover 3 and the middle casing 5 can be connected via the connecting member. Therefore, the components are connected more compactly, and the stability of the assembled components is improved. The recess 54 may be fixed with the first protrusion 32 via a snap fit, which ensures positioning and further improves the assembling of the components.

In the mobile terminal of the embodiment of the present disclosure, a second protrusion 61 is arranged on the back side surface of the front casing 6. The third connecting hole 62 may be a thread hole passing through the second protrusion 61 and fitting with the threaded connecting member. The second protrusion 61 and the connecting hole are aligned and fitted with each other. As shown in FIG. 4, the second protrusion 61 is disposed in the second connecting hole 57. The threaded connecting member (e.g. a bolt 2) passes through the first connecting hole 33 and is connected to the third connecting hole 62. Moreover, the middle casing 5 is disposed between the front casing 6 and the back cover 3, and the second protrusion 61 is positioned in the connecting hole 62, so that the middle casing 5 is fixed with the middle casing 5. The alignment and fitting between the middle casing 5 and the front casing 6 may improve the compactness and assembling stability of the components. The side surface of the second protrusion 61 fitted with the second connecting hole 57 is a step-shaped limiting surface 611, which improves manufacturability of the middle casing 5 and the front casing 6 and further realizes rapid alignment and assembling. The bolt 2 may be a bolt having higher reproducibility (i.e. the performance of being processed repeatedly) for the convenience of reproducibility and maintenance.

Similarly, in the mobile terminal of the embodiment of the present disclosure (as shown in FIG. 4), an extension protrusion 63 is arranged on the edge of the front side of a periphery of the front casing 6, and abuts an edge of the front side surface of the middle casing 5, for the convenience of assembling the front casing 6 and the middle casing 5. In the embodiment of the present disclosure, the battery cover 1 can be detachably connected to the back cover 3 via the connecting member or connecting structure. The connecting structure (e.g. a snap-fit) can ensure the connection and improve aesthetic appearance of the exterior surface of the mobile terminal. The outer peripheral surfaces of the battery cover 1, the middle casing 5 and the extension protrusion 63 form an outer side surface of the mobile terminal, such that the assembly surfaces of the battery cover 1 and the middle casing 5 are located at the peripheral side of the mobile terminal, thus facilitating the removal of the battery cover 1 and improving the operation efficiency.

In an embodiment of the present disclosure, the display screen 7 and the touch screen 8 can be connected with the front casing 6 via the connecting member, or alternatively, via fixed connecting structures. Referring to FIG. 4, a step groove is formed in the front side surface of the front casing 6. The display screen 7 is connected with a bottom of the step groove via a snap fit, a front side surface of the display screen 7 and a step surface of the step groove are in the same plane. The touch screen 8 is connected with a top of the step groove via a snap fit, a back side surface of the touch screen 8 abuts the step surface, and a front side surface of the touch screen 8 and the front side surface of the front casing 6 are in the same plane.

The mobile terminal provided in embodiments of the present disclosure can be a mobile phone, an iPad, a palm pilot, POS etc. The type of the mobile terminals is not limited in the present disclosure.

It shall be noted that in the embodiment of the present disclosure, the term “front side” or “front side surface” refers to a side or a side surface of the components close to the user operation interface or the display interface; while the term “back side” or “back side surface” refers to a side or a side surface of the components away from the user operation interface or the display interface.

Various embodiment of the disclosure are described in a progressive manner, and the same or similar parts in the embodiments can be referred to each other. The disclosure describes more on the feature of each embodiment that differs from other embodiments.

The above embodiments of the present disclosure cannot be constructed to limit the protection scope of the disclosure. Any modification, alternative and improvement within the spirit and the principle of the present disclosure shall be contained in the protection scope of the present disclosure.

What is claimed is:

1. A mobile terminal, comprising:
a middle casing (5) configured as a core support of the mobile terminal;
a front casing (6) fixed on a front side of the middle casing (5);
a back cover (3) fixed on a back side of the middle casing (5) and configured to cover the back side of the middle casing (5);
a battery cover (1) fixed on the back cover (3) and configured to cover a battery; and
a display screen (7) and a touch screen (8) arranged on the front casing (6) in series, wherein the front casing (6) is configured to support the display screen (7) and the touch screen (8), and the display screen (7) is positioned between the front casing (6) and the touch screen (8).

2. The mobile terminal according to claim 1, wherein the middle casing (5) comprises a frame (52) and a transverse beam (51) disposed in the frame (52) and dividing an area enclosed by the frame into a plurality of sub-areas, and wherein the plurality of sub-areas comprise at least a circuit board receiving area (53 or 55) and a battery receiving area (56).

3. The mobile terminal according to claim 2, wherein the back cover (3) has an operation window for battery attaching and detaching at a position of the back cover (3) corresponding to the battery receiving area (56).

4. The mobile terminal according to claim 1, wherein connecting holes are constructed in corresponding positions on edges of the front casing (6), the middle casing (5) and the back cover (3) respectively, the connecting holes comprise a first connecting hole (33), a second connecting hole (57) and a third connecting hole (62), and wherein:
the first connecting hole (33) is constructed in the back cover (3), the second connecting hole (57) is constructed in the middle casing (5), the third connecting hole (62) is constructed in the front casing (6), and the front casing (6), the middle casing (5) and the back cover (3) are connected via a threaded connecting member fitted with the connecting holes.

5. The mobile terminal according to claim 4, wherein a first protrusion (32) is arranged at a position of a front side surface of the back cover (3) corresponding to the first connecting hole (33), and a recess (54) is arranged at a position of the middle casing (5) corresponding to the first protrusion (32), and the recess (54) is fitted with the first protrusion (32).

6. The mobile terminal according to claim 5, wherein a second protrusion (61) is arranged on a back side surface of the front casing (6); the third connecting hole (62) is a thread hole passing through the second protrusion (61) and fitted with the threaded connecting member; and the second protrusion (61) is disposed in the second connecting hole (57).

7. The mobile terminal according to claim 6, wherein a side surface of the second protrusion (61) fitted with the second connecting hole (57) is a step-shaped limiting face (611).

8. The mobile terminal according to claim 1, wherein an extension protrusion (63) is arranged on an edge of a front side of a periphery of the front casing (6), and the extension protrusion (63) abuts an edge of the front side surface of the middle casing (5).

9. The mobile terminal according to claim 8, wherein the battery cover (1) is fixed with the back cover (3) via a snap fit; and outer peripheral surfaces of the battery cover (1), the middle casing (5) and the extension protrusion (63) form an outer side surface of the mobile terminal.

10. The mobile terminal according to claim 1, wherein a step groove is formed in a front side surface of the front casing (6), the display screen (7) is connected with a bottom of the step groove via a snap fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

11. The mobile terminal according to claim 2, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

12. The mobile terminal according to claim 3, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

13. The mobile terminal according to claim 4, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

14. The mobile terminal according to claim 5, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

15. The mobile terminal according to claim 6, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

16. The mobile terminal according to claim 7, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

17. The mobile terminal according to claim 8, wherein a step groove is formed in a front side surface of the front casing (6), the display screen (7) is connected with a bottom of the step groove via a snap-fit, and a front side surface of the display screen (7) and a step surface of the step groove are in a same plane;
the touch screen (8) is connected with a top of the step groove via a snap-fit, a back side surface of the touch screen (8) abuts the step surface, and a front side surface of the touch screen (8) and the front side surface of the front casing (6) are in a same plane.

18. The mobile terminal according to claim 9, wherein a step groove is formed in a front side surface of the front casing (6), the display screen (7) is connected with a bottom of the step groove via a snap-fit, and a front side surface of the display screen (7) and a step surface of the step groove are in a same plane;
and wherein the touch screen (8) is connected with a top of the step groove via a snap-fit, a back side surface of the touch screen (8) abuts the step surface, and a front side surface of the touch screen (8) and the front side surface of the front casing (6) are in a same plane.
